(19) United States
(12) Patent Application Publication
(10) Pub. No.: US 2009/0312457 A1
(43) Pub. Date: Dec. 17, 2009

(54) METAL OXIDE NANOPARTICLE, PROCESS FOR PRODUCING THE SAME, NANOPARTICLE DISPERSED RESIN AND METHOD FOR PRODUCING THE SAME

(75) Inventor: Shuzo Tokumitsu, Tokyo (JP)

Correspondence Address: NIXON & VANDERHYE, PC, 901 NORTH GLEBE ROAD, 11TH FLOOR, ARLINGTON, VA, 22203, US

(73) Assignee: HOYA CORPORATION, Tokyo (JP)

(21) Appl. No.: 12/519,846

(22) PCT Filed: Dec. 19, 2007
(86) PCT No.: PCT/JP2007/075044

§ 371 Date: Aug. 20, 2009

(30) Foreign Application Priority Data
Dec. 20, 2006 (JP) 2006-342550

(51) Int. Cl. B32B 15/02; C09K 3/00; C08K 9/00

(52) U.S. Cl. 523/205; 428/404; 252/182.33; 977/775

(57) ABSTRACT

Surface-modified metal oxide nanoparticles each having a core-shell structure and having an organic functional group on a surface, characterized in that the refractive index thereof is controlled by selecting at least one element constituting the metal oxide as a core from elements of the groups 4 and 5 of the periodic table, and a nanoparticles-dispersed resin comprising a matrix resin and the above metal oxide nanoparticles dispersed therein, the metal oxide nanoparticles being those which can be homogeneously dispersed in the matrix resin without causing secondary aggregation and which have a high refractive index and are colorless, the nanoparticles-dispersed resin being that which is obtained by homogeneously dispersing the above metal oxide nanoparticles in the matrix resin and which has a high refractive index and is excellent in colorless transparency.

### TECHNICAL FIELD

This invention relates to metal oxide nanoparticles and a process for the production thereof and to a nanoparticles-dispersed resin and a process for the production thereof. More specifically, this invention relates to metal oxide nanoparticles that have a core-shell structure, having a core made of metal oxides with a high refractive index whose average particle diameter of 1 to 20 nm, and having a surface modified with an organic functional group, that are homogeneously dispersible in a matrix resin without causing secondary aggregation and that have high refractivity and are free of coloring, a process for the efficient production thereof, a nanoparticles-dispersed resin that is obtained by homogeneously dispersing the above metal oxide nanoparticles in a matrix resin, that is suitable for a plastic ophthalmic lens, a sealant for LED (light-emitting diode), etc., and that has a high refractive index and is excellent in colorless transparency, and a process for the efficient production thereof.

### BACKGROUND ART

Conventionally, glass has been used as transparent materials in many cases from the viewpoints of optical properties, thermal stability, strength, etc. On the other hand, transparent plastics have been recently used since they are excellent in moldability, impact strength, light weight, etc., and they are widely used in the fields of automobile parts, signs, displays, illuminations, optical parts, light electric appliances, etc. As the fields for use of transparent plastics increase, there are increasing demands for higher-performance higher-function materials.

It is generally known that a plastic is improved in thermal stability, strength, etc., by incorporating inorganic fine particles into the plastic. When the plastic and the inorganic fine particles have different refractive indices, however, there is a problem that even if transparent inorganic fine particles are incorporated into a transparent matrix resin component, the transparency is impaired due to reflection, scattering, etc., of light in an interface to the above fine particles because of a difference in refractive index. It has been hence difficult to produce a transparent material full of a high concentration of inorganic fine particles.

For obtaining a transparent composite plastic highly full of inorganic fine particles, it has been general practice to take measures (1) to decrease the refractive index difference between a plastic and inorganic fine particles so as to make it as small as possible, or (2) to use nano-size inorganic fine particles.

However, the above method (1) cannot be applied when there is to be obtained a transparent composite plastic material having a higher refractive index than a matrix resin component. For example, in an LED sealant, a transparent resin material having a high refractive index is required efficiently obtaining emitted light. When the above sealant has a low refractive index, internal reflection occurs, and emitted light cannot be efficiently obtained.

Plastics are light in weight and not easily breaking, and are easy to dye, as compared with glass, so that they have come to be used for optical parts such as various lenses, etc., in recent years. When a plastic material is used, for examples for making an ophthalmic lens, however, the thickness of the lens increases with an increase in the strength of ophthalmic glasses when the plastic material has a low refractive index, so that not only the superiority of plastics having a light weight is impaired, but also it is undesirable from the viewpoint of sensuousness. In a concave lens in particular, the thickness of a lens circumference (edge thickness) increases, and there is caused a problem that birefringence or chromatic aberration easily takes place. There is therefore demanded a transparent resin material with a high refractive index in order to utilize the small-gravity plastic property and decrease the lens thickness.

As a method of obtaining a transparent resin material having a high refractive index, active studies for making a polymer having a high refractive index are under way, while not any material that is fully satisfactory in economic efficiency or other aspects has been obtained at present. It is hence thinkable to disperse nano-size high-refractivity inorganic fine particles, e.g., TiO₂ nanoparticles in a matrix resin. In this case, it is known that for inhibiting the reflection and scattering of light and maintaining transparency, it is desirable to use fine particles having a particle diameter smaller than the wavelength of visible light, e.g., fine particles with a size of about 10 nm or less.

When such nano-size fine particles are dispersed in a resin matrix, however, there is caused a problem that phase splitting takes place due to secondary aggregation, etc., of the above fine particles and that light is reflected or scattered to impair transparency, etc., when some interaction such as hydrogen bond, covalent bond, ionic bond, coordinate bond, or the like does not exist between the above fine particles and the resin.

For overcoming the above problem, there is known a method in which TiO₂ fine particles are surface-modified, for example, catechol employed as a ligand is bonded to TiO₂ fine particle surfaces (e.g., Chew. Mater. Vol. 16, page 1202 (2004)). In this case, however, there has been a problem that the TiO₂ fine particles cause a coloring in red.

### DISCLOSURE OF THE INVENTION

### Problems to be Solved by the Invention

Under the circumstances, it is an object of this invention to provide metal oxide nano particles that can be homogeneously dispersed in a matrix resin without causing secondary aggregation and that have a high refractive index and are free from coloring, and a nanoparticles-dispersed resin which is a homogeneous dispersion of the above metal oxide nanoparticles in a matrix resin and which has a high refractive index and is excellent in colorless transparency.

### Means to Solve the Problems

The present inventor has made diligent studies and as a result has found that the above object can be achieved by metal oxide nanoparticles each having a core-shell structure in which the core is composed of an oxide nanoparticle of a metal selected from elements of the groups 4 and 5 of the periodic table and its surface is modified with an organic functional group, and having a refractive index controlled by selecting a metal oxide for constituting the above core.

It has been further found that the above metal oxide nanoparticles can be easily produced by carrying out specific procedures. Further, it has been found that in order to disperse the above metal oxide nanoparticles homogeneously in the matrix resin, it is particularly advantageous to allow the matrix resin and the metals oxide nanoparticles to chemically bond to each other.

This invention has been completed on the basis of these findings.

That is, this invention provides

(1) metal oxide nanoparticles each having a core formed of a metal oxide having at least one element selected from elements of the groups 4 and 5, and a shell having a coating portion that has Si and/or C-e element(s) and that is formed on the circumference of said core to coat said core, and an organic functional group that is bonded so said Si and/or Ge element(s),

(2) metal oxide nanoparticles of the above (1), which have a molar ratio of [M]/[Si.Ge]≧4,

in which [M] is a molar amount of the at least one element selected from elements of the groups 4 and 5, and [Si.Ge] is a molar amount of Si and/or Ge element(s) contained in the coating portion of said shell,

(3) metal oxide nanoparticles of the above (1) or (2), which have a molar ratio of [F]/[Si.Ge] 1 or 2,

in which [F] is a molar amount of molecules of said organic functional group contained in said shell, and [Si.Ge] is a molar amount of Si and/or Ge element(s) contained in said shell,

(4) metal oxide nanoparticles of any one of the above (1) to (3), wherein said core has a volume factor of 0.6 or more but less than 1,

(5) metal oxide nanoparticles of any one of the above (1) to (4), wherein the metal oxide of said core has a crystalline structure,

(6) metal oxide nanoparticles of any one of the above (1) to (4), wherein the metal oxide of said core is amorphous,

(7) metal oxide nanoparticles of any one of the above (1) to (6), wherein the metal oxide of said core represents at least two members selected from TiO₂, ZrO₂, HfO₂, Nb₂O₅ and Ta₂O₂,

(8) a process for producing metal oxide nanoparticles of any one of the above (1) to (7), wherein said coating portion and said organic functional group is formed from identical raw materials having Si and/or Ge element(s),

(9) a process for producing metal oxide nanoparticles as recited in the above (B), wherein the raw material for said coating portion and said organic functional group is a silane coupling agent and/or a germanium coupling agent,

(10) a process for producing metal oxide nanoparticles as recited in the above (8) or (9), wherein the raw material for said coating portion and said organic functional group is Rn—Y-Xm in which R is an organic functional group, Y is Si and/or Ge, X is OR′, Cl, Br or OCOR″ in which R′ and R″ are hydrogen atoms or hydrocarbon groups, and n and m are numbers of 1 or more but 3 or less and satisfy n+m=4,

(11) a process for producing metal oxide nanoparticles as recited in any one of the above (8) to (10), which comprises the steps of

(A) forming a reversed micelle internally having fine water globules in an organic solvent,

(B) allowing each of an alkoxide compound of at least one metal M selected from elements of the group 4 and 5, a silane coupling agent and/or a germanium coupling agent having non-hydrolyzable organic functional groups and hydrolyzable groups, and optionally, a hydrolyzable material to undergo hydrolysis condensation using, as a reaction site, an inside of the reversed micelle formed in said step (A), to form a silicon compound and/or a germanium compound having a non-hydrolyzable group and a hydroxyl group around oxide particles of the metal M, and

(C) heat-treating the reaction solution obtained in said step (B), to form metal oxide nanoparticles each having a core-shell structure having an oxide particle of the metal M as a core, the silicon compound and/or the germanium compound as a coating portion and the non-hydrolyzable group as a shell,

(12) a process for producing metal oxide nanoparticles as recited in any one of the above (8) to (10), which comprises the steps of

(D) forming a reversed micelle internally having fine water globules in an organic solvent,

(E) adding an alkoxide compound of at least one metal M selected from the elements of the groups 4 and 5, a silane coupling agent and/or a germanium coupling agent having non-hydrolyzable organic functional groups and hydrolyzable groups, and optionally, a hydrolyzable material to the organic solvent in said step (D), and

(F) heat-treating the organic solvent in said step (E) to allow each to undergo dehydration-condensation,

(13) a process for producing metal oxide nanoparticles as recited in the above (11) or (12), wherein said heat treatment is heat treatment by microwave,

(14) a process for producing metal oxide nanoparticles as recited in any one of the above (11) to (13), wherein the metal oxide particles of the metal N is crystallized by said heat treatment,

(15) a process for producing metal oxide nanoparticles as recited in any one of the above (11) to (14), wherein the fine globules in said reversed micelle have an acidity,

(16) a nanoparticles-dispersed resin comprising a matrix resin and the metal oxide nanoparticles recited in any one of the above (1) to (7) which are dispersed therein,

(17) a nanoparticles-dispersed resin as recited in the above (16), wherein said matrix resin and said organic functional group of each shell of said metal oxide nanoparticles are chemically bonded to each other,

(18) a nanoparticles-dispersed resin as recited in the above (16) or (17), wherein said matrix resin is polythiourethane,

(19) a nanoparticles-dispersed resin as recited in the above (16) or (17), wherein said matrix resin is a silicone resin,

(20) a process for producing the nanoparticles-dispersed resin recited in any one of the above (16) to (19), which comprises using said matrix resin and said organic functional group in a manner that one of them has a group of Si—H and the other has a group of C=C, and

(21) a process for producing a nanoparticles-dispersed resin as recited in the above (19) or (20), wherein said matrix resin is a silicone resin, and the hydrosilyl group Si—H and the vinyl group C=C are allowed to undergo condensation and crosslinking by hydrosilylation in the presence of a platinum complex catalyst.

### EFFECT OF THE INVENTION

According to this invention, there can be provided metal oxide nanoparticles that each have a corey shell structure in which metal oxide particles with a high refractive index having an average particle diameter of approximately 1 to 20 nm are used as cores and the surfaces thereof are modified with an organic functional group, that can be homogeneously dispersed in a matrix resin without causing secondary aggregation and that have a high refractive index and are free of coloring, a process for efficiently producing this product, a nanoparticles-dispersed resin which is a homogeneous dispersion of said metal oxide nanoparticles in a matrix resin, which is suitable for plastic ophthalmic lenses or as a sealant for LED and which has a high refractive index and is excellent in colorless transparency, and a process for efficiently producing the same.

### BRIEF DESCRIPTION OF DRAWINGS

FIG. 1 shows XRD patterns of products in Example 1.1 and Example 2.1.

### PREFERRED EMBODIMENTS OF THE INVENTION

First, the metal oxide nanoparticles of this invention will be explained.

The metal oxide nanoparticles of this invention are surface-modified metal oxide nanoparticles having an organic functional group on each surface and having a core-shell structure each, and they have a feature in that their refractive index is controlled by using, as an element for constituting a metal oxide constituting the core from, at least one element selected from elements of the groups 4 and 5 of the periodic table, preferably, by selecting at least one from TiO₂, ZrO₂, HfO₂, Nb₂O₅ and Ta₂O₅.

The metal oxide nanoparticles of this invention have been developed for homogeneously dispersing them in a matrix resin without causing secondary aggregation in order to provide nanoparticles-dispersed resin that is a colorless, transparent and high-refractivity composite material. Therefore, as a metal oxide for constituting the core, preferably, TiO₂, ZrO₂, HfO₂, Nb₂O₅ or Ta₂O₅ is selected as an oxide with a high refractive index from oxides of metals coming under the groups 4 and 5 of the periodic table. These metal oxides may be used singly or in combination of two or more of them. Of these, TiO₂ is more preferred in that it has a high refractive index and is easy to produce.

When such metal oxide particles with a high refractive index are dispersed in a matrix resin, and when they have a large particle size, scattering of light takes place due to a refractive index difference from the matrix resin, the transmittance is decreased, and it is difficult to obtain a composite material excellent in transparency. It is said that the particle diameter is generally desirably 10 nm or less for causing no scattering in the visible light region. However, even when the particle size is sufficiently small, particles undergo aggregation to generate secondary particles and scattering takes place if they cannot be homogeneously dispersed in a matrix resin. For satisfying both high refractivity and high transmittance, fine particles have to be homogeneously dispersed in a matrix resin. For this purpose, desirably, the fine particles preferably have high affinity (compatibility) to a matrix resin, and more preferably have a surface ligand that forms a chemical bond to a matrix resin.

Further, when the application of a composite material to optical materials is taken into account, preferably, they are colorless. However, TiO₂ nanoparticles are easily colored when a surface ligand is introduced, and it is difficult to satisfy both the colorlessness and the dispersibility thereof in a matrix resin by a known method (the synthesis example of high-dispersibility TiO₂ nanoparticles by a known method has been made for achieving an object to provide a dye-sensitized solar cell or photocatalyst, and the coloring has not posed any big problem). For securing dispersibility, a surface ligand has to form a strong chemical bond to a TiO₂ particle surface, and in this case, electrons flow into a Ti3d orbit from the ligand to cause a coloring (since atoms present on nanoparticle surfaces account for up to 50% of the whole, coloring becomes outstanding).

The metal oxide nanoparticles of this invention are colorless nanoparticles than overcome the above coloring problem and that has a core-shell structure in which they have an organic functional group on each surface and surface-modified, so that they have excellent dispersibility in a matrix and can inhibit a decrease in transmittance caused by light scattering.

The metal oxide nanoparticles of this invention have a feature that the coating portion of the shell has a small thickness owing to the production process thereof and raw materials therefor. Therefore, there can be produced metal oxide nanoparticles, which have a molar amount ratio of [M]/[Si.Ge]≧4, in which [M] is a molar amount of at least one element selected from elements of the groups 4 and 5 contained in the core, and [Si.Ge] is a molar amount of Si and/or Ge element(s) contained in the coating portion of the above shell.

When such metal oxide nanoparticles are produced, conventionally, there is employed a production method in which a core is first formed, then a shell (coating portion) is formed on the core surface and an organic ligand (organic functional group) is introduced to the thus-obtained core/shell particle. In this invention, in contrast to such a conventional method, the coating portion of the shell and the organic functional group are formed from identical raw materials, so that the film thickness of the coating portion can be decreased.

Since the refractive index of the shell comes to be small as compared with the refractive index of the core, it follows that the ratio of the shell should be smaller for obtaining a composite having a higher refractive index. In this case, the ratio of the organic functional group that contributes to dispersibility may decrease, and the dispersibility of the nanoparticles in a matrix resin may be possibly impaired. For satisfying both an improvement of an effective composite in refractive index and the dispersibility thereof in a matrix resin, the ratio of molar amount [M] of metal element forming the core and the molar amount [Si.Ge] of silicon or germanium contained in the shell, [M]/[Si Ge] is preferably 4 or more. When fine particles having a core formed of anatase TiO₂ and a shell formed of mercaptopropyltrimethoxysiiane and a ratio of [M]/[Si Ge]=4 are taken as an example, it is estimated that they have a refractive index of approximately 1.9, and it is estimated that a composite obtained by mixing 25% by volume of the above fine particles with a matrix resin having a refractive index of 1.5 has a refractive index of 1.6. From the viewpoint of refractivity, the value of [M]/[Si.Ge] is preferably larger, and more preferably 6 or more, still more preferably 8 or more.

The above organic functional group is derived from a silane coupling agent and/or a germanium coupling agent (to be referred to as “silane coupling agent, etc.” hereinafter) that are/is used for forming the shell as will be explained later, and the above shell is constituted of polyorganosiloxane having an organic functional group formed by hydrolysis of the above silane coupling agent, etc. The above germanium coupling agent refers to a conventionally known silane coupling agent whose Si element is replaced with Ge element. Examples of the above organic functional group include 3 mercaptopropyl, 3-(meth)acryloxypropyl, 3-glycidoxypropyl, 2-(3,4-epoxycyclohexyl)ethyl, N-(2-aminoethyl)-3-aminopropyl, 3-aminopropyl, allyl, vinyl, etc.

The metal oxide nanoparticles of this invention have a feature that the ratio of molar amount [F] of molecules of the organic functional group contained in the shell and the molar amount [Si.Ge] of the Si and/or Ge element(s), [F]/[Si.Ge], is 1 or 2 owing to production process thereof or raw materials that are used.

When such metal oxide nanoparticles are produced, conventionally, there is employed a production method in which a core is first formed, then a shell (coating portion) is formed on the core surface and an organic ligand (organic functional group) is introduced to the thus-obtained core/shell particle. In this invention, in contrast to the above conventional method, the coating portion of the shell and the organic functional group are together formed from identical raw materials, so that the metal oxide nanoparticles of this invention have a feature that the resultant [F]/[Si.Ge] value is the same as the [F]/[Si.Ge] value of raw materials that are used. In this case, for reasons of polysiloxane formation, the [F]/[Si.Ge] value becomes 1 or 2.

The metal oxide nanoparticles of this invention have a feature that the organic functional group of the shell is bonded to Si and/or Ge elements of the coating portion of the shell due to the production process thereof or raw materials that are used. That is because the coating portion and organic functional group of the shell are together formed from identical raw materials and the shell is hence formed with maintaining the structure of the silane coupling agent, etc.

In the metal oxide nanoparticles of this invention, the refractive index thereof can be controlled by selecting at least one of the above metal oxides for constituting the core as required, and the refractive index thereof can be controlled by changing the average particle diameter of the core in the range of 1 to 20 nm. This refractive index is generally approximately 1.6 to 2.7, and the volume factor of the core in the core-shell structure is generally approximately 0.6 to less than 1.

The volume factor of the core can be also estimated from the results of elemental analysis of the fine particles. When the content of the core oxide in the fine particles is Mm mol and when the content of silicon or germanium forming the shell is Ms Ms mol, the volume of the core Vm and the volume of the shell Vs are Vm=Mm×Wm/Dm and Vs=Ms×Ws/Ds, respectively. The above Wm and Ws are molecular weights of the core and the shell, and Dm and Ds are densities of materials constituting the core and the shell. Therefore, the volume factor of the core can be calculated by Vm/(Vm+Vs).

The radius r of the core can be controlled on the basis of the molar ratio [water/surfactant] of water and a surfactant that are used for forming the reversed micelle as will be explained in the production process to be described later, and the thickness of the shell can be controlled on the basis of the use ratio of the metal alkoxide used for forming the core and the silane coupling agent used for forming the shell.

Further, the metal oxide forming the core may have a crystal structure or may be amorphous. The crystal structure or being amorphous can be controlled by selecting a heating method in heat treatment at the final stage as will be explained in the process for the production of metal oxide nanoparticles which will be described later.

When the metal oxide constituting the core is amorphous, a band edge becomes dim, and photocatalytic activity decreases, so that the destruction of the resin can be prevented. On the other hand, when it has a crystal structure, the mobility of carriers is high, and holes and electrons generated within each particle move onto each particle surface and have photocatalytic activity such as decomposition of an organic substance, etc., to which they come in contact. When it is amorphous, the mobility of carriers is low, and carriers that are generated by light absorption are liable to be caught on a capture level within each particle and do not easily reach each particle surface, so that the photocatalytic activity thereof is low.

When the metal compound constituting the core is amorphous, an amorphous composite metal oxide can be formed by selecting two or more oxides which do not easily form a crystal from TiO₂, ZrO₂, HfO₂, Nb₂O₅ and Ta₂O₅ as required. In this case, it is expected that the physical properties of the metal oxide nanoparticles can be controlled without impairing their stability (dispersibility, particle form). Further, when such a composite metal oxide is formed, it is also expected that a surface ligand is stably fixed.

The process for producing metal oxide nanoparticles, provided by this invention, will be explained below.

The process for producing metal oxide nanoparticles in this invention has a feature that the formation of fine particles, the formation of shells and the introduction of a functional group are concurrently carried out in the co-presence of a silane coupling agent. Specifically, there can be employed a process which comprises the steps of (A) forming a reversed micelle internally having fine water globules in an organic solvent, (B) allowing each of an alkoxide compound of at least one metal M selected from elements of the group 4 and 5, a silane coupling agent, etc., having a none hydrolyzable organic functional group and a hydrolyzable group, and optionally, a material having a hydrolyzable group alone to undergo hydrolysis condensation using, as a reaction site, an inside of the reversed micelle formed in the above step (A), to cause a silicon compound and/or a germanium compound having a non-hydrolyzable group and a hydroxyl group to adhere to the circumferences of oxide particles of the metal M, and (C) heat-treating the reaction solution obtained in the above step (B), to Form metal oxide nanoparticles each having a core-shell structure in which the core is an oxide particle of the metal M and the shell is an oxide of the silicon compound and/or the germanium compound having a non-hydrolyzable organic functional group.

### [Step (A)]

The step (A) As a step in which a reversed micelle internally having fine water globules is formed in an organic solvent.

As the organic solvent in the above step (A), a nonpolar solvent having no miscibility with water, specifically, at least one selected from aliphatic hydrocarbon, alicyclic hydrocarbon and aromatic hydrocarbon solvents can be used, while xylene is preferred in view of a boiling point, etc.

For forming the reversed micelle, any one of conventional surfactants that are generally used for forming a reverse micelle can be selected and used as required. As a typical example of these surfactants, there is sodium bis-2-ethylhexylsulfosuccinate. The use ratio of water and the above surfactant for the reversed micelle formation as a water/surfactant molar ratio is generally approximately from 1 to 50, preferably from 2 to 40. The size of the reversed micelle to be formed can be selected by selecting the above molar ratio. In this invention, the above molar ratio is more preferably about 10.

The amount of water to be used per 100 parts by volume of the nonpolar solvent is generally 0.5 to 20 parts by volume, preferably 1 to 15 parts by volume. Further, since the metal alkoxide and silane coupling agent are allowed to undergo a hydrolysis-condensing reaction in the subsequent step using the above reversed micelle as a reaction site, the formation of an acidic reversed micelle is preferred, so that a proper amount of acids such as sulfuric acid, hydrochloric acid, nitric acid, p-toluenesulfonic acid, etc., are used, and preferably a proper amount of p-toluenesulfonic acid is used.

The reversed micelle solution can be prepared by mixing the above nonpolar solvent, water, surfactant and acids and fully stirring the mixture generally at room temperature until it forms a homogeneous solution.

### [Step (B)]

The step (B) is a step in which an inside of the reversed micelle formed in the above step (A) is used as a reaction site, and each of an alkoxide compound of at least one metal M selected from Ti, Zr, Hf, Nb and Ta and a silane coupling agent having a non-hydrolyzable organic functional group and a hydrolyzable group is allowed to undergo hydrolysis and condensation, to allow silicon and/or germanium compound(s) having the non-hydrolyzable organic functional group and a hydroxyl group to adhere to the circumference of each oxide particle of the metal M.

In the above step (B), the alkoxide compound of the metal M is not specially limited so long as it can form an oxide of the metal M by the hydrolysis-condensing reaction and can form a core. The titanium alkoxide compound when the above metal oxide is titanium preferably includes titanium tetramethoxide, titanium tetraethoxide, titanium tetra-n-propoxide, titanium tetraisopropoxide, titanium tetra-n-butoxide, titanium tetraisobutoxide, titanium tetra-sec-butoxide, titanium tetra-tert-butoxide, etc. These may be used singly or in combination of two or more of them. Of these, titanium tetraisopropoxide is preferred in view of its reactivity.

On the other hand, the silane coupling agent having a non-hydrolyzable organic functional group and a hydrolyzable group is preferably a silane coupling agent of which the hydrolyzable group is an alkoxyl group. The alkoxysilane compound having a non-hydrolyzable organic functional group includes 3-mercaptopropyltrimethoxysilane, 3-(meth)acryloxypropyltrimethoxysilane, 3-glycidoxypropyl-trimethoxysilane, 2-(3,4-epoxycyclohexyl)ethyltrimethoxysilane, N-(2-aminoethyl)-3-aminopropyltrimethoxy-silane, 3-aminiopropyltrimethoxysilane, allyltriethoxy-silane, vinyltris(2-methoxyethoxy)silane, etc. These may be used singly or in combination of two or more of them. The non-hydrolyzable organic functional group of the above silane coupling agent in kind can be selected as required depending upon a matrix resin that is used when a composite material is prepared by dispersing the metal oxide nanoparticles in the matrix resin. A coupling agent formed by replacing the St element of the above silane coupling agent with a Ge element (this is referred to as “germanium coupling agent” in this invention) can be also used. The silane coupling agents and/or germanium coupling agents may be used singly or in combination of two or more of them.

In this case, hydrolyzable silicon and/or germanium compound(s) having no organic functional group (this is referred to as “hydrolyzable material” in this invention) may be added in an arbitrary amount in combination with the silane coupling agent, etc. The hydrolyzable material can be represented by Y-X₄ (in which Y is Si or Ge, X is OR, Cl, Br or OCOR, in which R is a hydrogen atom or a hydrocarbon group, and four Xs may be the same or different). The silicon compound of the hydrolyzable material includes silicon tetrachloride, silicon tetraacetate, etc., while tetraethoxysilane which has a hydrolytic speed equivalent to that of the silane coupling agent is more preferred. When these compounds are added, the ratio of the core and the shell can be adjusted without changing the density of the organic functional group introduced by the silane coupling agent, etc., and as a result, the refractive index of the fine particles can be finely controlled. Further, when these silicon compounds having no organic functional groups are added, there is also produced an effect that the polymerization degree of polyorganosiloxane bonds in the step (C) can be increased, and the reproducibility of dispersibility of the formed fine particles can be more improved.

In the above step (B), the hydrolysis-condensing reaction of the silane coupling agent, etc., is very slow as compared, for example, with the hydrolysis-condensing reaction of titanium alkoxide. Therefore, preferably, the silane coupling agent is first added to the reversed micelle solution, and the mixture is left at room temperature for approximately 5 to 36 hours, preferably, approximately 20 hours, to allow it to react partially. Then, a solution of an alkoxide of the metal M, e.g., titanium tetraalkoxide in a solvent such as n-hexanol is added thereto. In this case, since the above titanium tetraalkoxide is well dissolved in an organic solvent of reversed micelles, so that it is diffused to collide with the reversed micelle, the hydrolysis-condensing reaction takes place due to water, and TiO₂ in an amorphous form is generated in the reversed micelle.

The silicon and/or germanium compound(s) having an organic functional group and a hydroxyl group, generated by the hydrolysis-condensing reaction of the silane coupling agent, etc., adheres to the surface of each of the thus-generated TiO₂ particles.

### [Step (C)]

The step (C) is a step in which the reaction solution obtained in the above step (B) is heat-treated to form metal oxide nanoparticles each having a core-shell structure in which the core is an oxide particle of the metal M and the shell is an oxide of the silicon and/or germanium having a non-hydrolyzable organic functional group.

In the above step (C), the reaction solution obtained in the above step (B) is heat-treated, whereby the hydrolysis-condensing reaction of the silane coupling agent, etc., is completed, and the basket-like shell formed of polyorganosiloxane having a non-hydrolyzable organic functional group is formed on the circumference of the core formed of a metal oxide particle, e.g., TiO₂ particle.

The process for producing metal oxide nanoparticles, provided by this invention, has a characteristic feature that the formation of the fine particle core, the formation of the shell and the introduction of the functional group are carried out at the same time in the co-presence of the silane coupling agent. Specifically, there can be employed a process comprising the steps of (D) forming a reversed micelle internally having fine water globules in an organic solvent, (E) adding an alkoxide compound of at least one metals selected from the elements of the groups 4 and 5, a silane coupling agent and/or a germanium coupling agent having a non-hydrolyzable organic functional group and a hydrolyzable group, and optionally, a hydrolyzable material to the organic solution in the above step (D), and (F) heat-treating the organic solvent in said step (E) to allow each to undergo dehydration-condensation.

### [Step (D)]

The step (D) is a step in which a reversed micelle internally having fine water globules is formed in an organic solvent. Details thereof are similar to those in the above step (A) and hence are omitted.

### [Step (E)]

The step (B) is a step in which an alkoxide compound of at least one metal M selected from Ti, Zr, Hf, Nb and Ta, and the silane coupling agent, etc., having a non-hydrolyzable organic functional group and a hydrolyzable group are respectively added to the organic solvent in which the reversed micelle Internally having fine water globules is formed in the above step (D).

In the above step (D), the alkoxide compound of the metal M is not specially limited so long as it can form an oxide of the metal M by the hydrolysis-condensing reaction and can form a core. The titanium alkoxide compound when the above metal oxide is titanium preferably includes titanium tetramethoxide, titanium tetraethoxide, titanium tetra-n-propoxide, titanium tetraisopropoxide, titanium tetra-n-butoxide, titanium tetraisobutoxide, titanium tetra-sec-butoxide, titanium tetra-tert-butoxide, etc. These may be used singly or in combination of two or more of them. Of these, titanium tetraisopropoxide is preferred in view of its reactivity.

On the other hand, the silane coupling agent having a non-hydrolyzable organic functional group and a hydrolyzable group is preferably a silane coupling agent of which the hydrolyzable group is an alkoxyl group. The alkoxysilane compound having a non-hydrolyzable organic functional group includes 3-mercaptopropyltrimethoxysilane, 3-(meth)acryloxypropyltrimethoxysilane, 3-glycidoxypropyltrimethoxysilane, 2-(3,4-epoxycyclohexyl) ethyltrimethoxysilane, N-(2-aminoethyl)-3-aminopropyl-trimethoxysilane, 3-aminopropyltrimethoxysilane, allyltriethoxysilane, vinyltris (2-methoxyethoxy)silane, etc. These may be used singly or in combination of two or more of them. The non-hydrolyzable organic functional group of the above silane coupling agent in kind can be selected as required depending upon a matrix resin that is used when a composite material is prepared by dispersing the metal oxide nanoparticles in the matrix resin. A coupling agent formed by replacing the Si element of the above silane coupling agent with a Ge element (this is referred to as “germanium coupling agent” in this invention) can be also used. The silane coupling agents and/or germanium coupling agents may be used singly or in combination of two or more of them.

In this case, hydrolyzable silicon and/or germanium compound(s) having no organic functional group (this is referred to as “hydrolyzable material” in this invention) may be added in an arbitrary amount in combination with the silane coupling agent, etc. The hydrolyzable material can be represented by Y-X₁ (in which Y is Si or Ge, X is OR, Cl, Br or OCOR, in which R is a hydrogen atom or a hydrocarbon group, and four Xs may be the same or different). The silicon compound of the hydrolyzable material includes silicon tetrachloride, silicon tetraacetate, etc., while tetraethoxysilane which has a hydrolytic speed equivalent to that of the silane coupling agent is more preferred. When these compounds are added, the ratio of the core and the shell can be adjusted without changing the density of the organic functional group introduced by the silane coupling agent, etc., and as a result, the refractive index of the fine particles can be finely controlled. Further, when these silicon compounds having no organic functional groups are added, there is also produced an effect that the polymerization degree of polyorganosiloxane bonds in the step (C) can be increased, and the reproducibility of dispersibility of the formed fine particles can be more improved.

In the above step (E), the hydrolysis-condensing reaction of the silane coupling agent, etc., is very slow as compared, for example, with the hydrolysis-condensing reaction of the titanium alkoxide. Therefore, preferably, the silane coupling agent, etc., are first added, and the mixture is left at room temperature for approximately 5 to 36 hours, preferably, approximately 20 hours, to allow it to react partially. Then, the alkoxide of the metal M is added thereto. In this manner, the subsequent hydrolysis-condensing reaction can be allowed to take place easily.

### [Step (F)]

In this step (F), the reaction solution obtained in the above step (E) is heat-treated, whereby a hydrolysis-condensing reaction takes place, and there can be formed metal oxide nanoparticles each having a cores shell structure in which the core is an oxide particle of the metal M and the shell is an oxide of silicon and/or germanium compound's) having a non-hydrolyzable organic functional group.

The heat treatment may be carried out by heating it with microwave or may be carried out by heating it in an oil bath. For the microwave heating, generally, there is employed the conditions of heating at a temperature of 6 to 200° C. for approximately 6.5 to 6 hours. In this case, the metal oxide constituting the core is generally an oxide having a crystal structure.

For the heating in an oil bath, generally, there is employed the condition of heating at a temperature of 6 to 200° C. for 0.5 to 6 hours. In this case, generally, the metal oxide constituting the core is amorphous.

After the heat treatment is carried out in the above manner, an alcohol such as methanol, etc., is added to destroy the reversed micelle and to form a homogeneous solution of the surfactant, and a precipitate of the metal oxide nanoparticles having the core-shell structure each is generated. There may be employed a constitution in which the above precipitate is washed with an alcohol, then centrifugally separated and taken out, or a constitution in which it is allowed to stand, a supernatant is removed and the above precipitate is taken out.

In the above manner, there can be obtained metal oxide nanoparticles each having a core-shell structure having an organic functional group on its surface.

These nanoparticles generally have a core average particle diameter of approximately 1 to 20 nm, a core volume factor of 0.1 to less than 1 and a refractive index of approximately 1.6 to 2.7, and they are colorless and are easily homogeneously dispersed in a matrix resin or a non-polar solvent without causing secondary aggregation.

The nanoparticles-dispersed resin of this invention will be explained below.

The nanopartlcles-dispersed resin of this invention is a composite material containing a matrix resin and the above metal oxide nanoparticles of this invention dispersed therein.

The matrix resin for use in the nanoparticles-dispersed resin of this invention is not specially limited, and it is selected as required depending upon use fields of nanoparticles-dispersed resins to be obtained. Examples of the matrix resin include a silicone resin, an epoxy resin, a polydisulfide resin, a polythiourethane resin, an acrylic resin, a polycarbonate resin, a polyolefin resin, a polyamide resin, a polyester resin, a polyphenylene ether resin, a polyarylene sulfide resin, etc. These matrix resins may be used singly or in combination of two or more of them. Of these, a silicone resin and an epoxy resin for use as a sealant of LED and polydisulfide and polythiourethane for use as a plastic ophthalmic lens material are preferred, and a silicone resin and polythiourethane are particularly preferred.

In the nanoparticles-dispersed resin of this invention, it is preferred from the viewpoint of dispersibility of the metal oxide nanoparticles that the matrix resin and the metal oxide nanoparticles each having a core-shell structure having an organic functional group on its surface should be chemically bonded. Specifically, when the matrix resin is a polythiourethane or when it is a silicone resin, it can be easily chemically bonded to the metal oxide nanoparticles.

Further, preferred is a nanoparticles-dispersed resin obtained by using the matrix resin and metal oxide nanoparticles in a manner that one of these two components has a group of Si—H and the other has a group of C═C. That is, when the matrix resin has Si—H groups, metal oxide nanoparticles having C=C groups are used. When the matrix resin has C-C groups, metal oxide nanoparticles having Si—H groups are used.

According to this invention, there is also provided a process for producing nanoparticles-dispersed resin, wherein the matrix resin to bond to the metal oxide nanoparticles is a silicone resin, and the hydrosilyl group Si—H and the vinyl group are allowed to undergo condensation and crosslinking by hydrosilylation in the presence of a platinum complex catalyst.

As a method of curing a silicone resin as a sealant for LED, there is most generally employed a method of condensing Si—H and Si—CH═CH₂ in the presence of a platinum complex catalyst. In this reaction, it is thought that curing is caused by newly generating a bond of Si—CH₂—CH₂—Si (hydrosilylation reaction), causing a molecule having Si—H (silicone condensate having a polymerization degree of 4 to 10) and a molecule having Si—CH═CH₂ to be crosslinked and thereby increasing a molecular weight. Generally, the curing of a silicone resin as a sealant for LED is carried out by using a compound having S—(CH═CH₂) as a liquid A and a compound having Si—H as a liquid B (which is thought to be a mixture with a platinum complex) and mixing them immediately before the curing.

The above procedure has an advantage in that no free molecule is generated when the curing (condensing reaction) takes place. The advantage is therefore that a desired resin molded article can be obtained by simply placing raw materials in a mold and heating them. The present inventor has therefore had an idea that when a composite is prepared by mixing fine particles with a silicone resin that is in commercial distribution at present, the existence of Si—H or C═C somewhere in a particle ligand is sufficient. More preferably, it is thinkable that an allyl group exists as a ligand.

In the nanoparticles-dispersed resin of this invention, the amount of the metal oxide nanoparticles of this invention per 100 parts by mass of the matrix resin is generally 10 to 300 parts by mass, preferably 50 to 200 parts by mass.

When a nanoparticles-dispersed resin is obtained by employing polythiourethane (refractive index 1.60) as a matrix resin and dispersing the metal oxide nanoparticles of this invention in the above amount by chemical bonding, its transmittance is generally 75% or more, its haze value is generally 10% or less, and its refractive index is 1.62 to 2.4.

Further, when a nanoparticles-dispersed resin is obtained by employing a silicone resin (refractive index 1.51) as a matrix resin and dispersing the metal oxide nanoparticles of this invention in the above amount by chemical bonding, its transmittance is generally 75% or more, its haze value is generally 10 E or less, and its refractive index is 1.51 to 2.2.

The methods for measuring the above transmittance, haze value and refractive index will be explained later.

The nanoparticles-dispersed resin as a composite material in this invention has metal oxide nanoparticles homogeneously dispersed in a matrix resin without causing their secondary aggregation, has a high refractive index and has excellent colorless transparency, and it is suitably used as a sealant for LED or a material for plastic ophthalmic lenses.

### EXAMPLES

This invention will be explained further in detail with reference to Examples hereinafter, while this invention shall not be limited by these Examples.

The volume factor and refractive index of a core are estimated as follows. One example will be explained with regard to a supposed case where a core is TiO₂, the coating portion of a shell is SiO₂ and a silane coupling agent having an organic functional group and Si element in equimolar amounts is used. The estimation is made with using three factors of Ti (symbol t), Si (symbol s) and organic functional group (symbol r).

First, metal oxide nanoparticles are subjected to elemental analysis to determine molar ratios (Mt, Ms) of TI element and Si element. In this case, the molar ratio of the organic functional group is equal to Ms.

Then, weight ratios are calculated on the basis of the obtained molar ratios with using molecular weights (molecular formula weights) W of the elements. The weight ratios of TiO₂, SiO₂ and organic functional group are Mt×Wt, Ms×Ws and Ms×Wr, respectively.

Then, volume ratios are calculated on the basis of the obtained weight ratios with using densities d (g/cm³) of the elements. The volume ratios of TiO₂, SiO₂ and the organic functional group are Mt×Wt/dt, Ms×Ws/ds and Ms×Wr/dr, respectively. The volume factor of each is calculated as a factor when the total of three factors is 1.

The refractive index of metal oxide nanoparticles is calculated by totaling the products of the above-obtained volume factors and the refractive indices of the respective materials.

Measurements were made by the use of the following apparatus as measuring apparatus.

### <Measuring Apparatus>

(1) Powder X-ray diffraction (XRD): Measured with “MXP-18A” (X-ray source: copper Kα ray, wavelength 0.15418 nm) supplied by Mac Science Corporation at 20° C.

(2) Nuclear magnetic resonance (NMR) spectrum: “JMN-AL400” supplied by JEOL Ltd. Measurements were made using deuterated chloroform as a solvent with tetramethylsilane as a reference 0 ppm at 20° C.

(3) Transmission electron microscope (TEM) observation: Made with “JEM-3200F′S” (accelerating voltage 300 kV, vacuum degree during observation 2.66×107 Pa, supplied by JEOL Ltd.

(4) Light transmittance: Measured with a visible-ultraviolet absorption spectrophotomreter (“PV-1700” supplied by Shimadzu Corporation).

(5) Refractive index measurement: Made with an Abbe refractometer “MAR-4T” supplied by Atago Co., Ltd.

(6) Elemental analysis: Carried out by inductively coupled plasma atomic emission spectrometry.

Further, particles were identified by the following method.

### <Identification of Particles>

(1) Core Size Measurement

A chloroform dispersion solution as a formed product was dropped on a copper mesh for TEM observation, and a vacuum-dried sample was subjected to TEM observation. With regard to 200 pieces of particles on a field of a photograph which was taken at a magnification of 1,000,000 times, an average of particle diameters was determined and used as an average particle diameter.

(2) Crystallizability Measurement

A chloroform dispersion solution of a product was applied to a silicon substrate, and XRD measurement was made using the applied substrate as a sample. The thus-obtained diffraction pattern was compared with PDF card data to identify a crystal structure. Further, a product that gave no diffraction pattern was identified as having an amorphous structure.

(3) Measurement of Surface Ligand

A deuterated chloroform solution of a product was measured for ¹H-NMR spectrum, and a ligand was identified.

(4) Compositional Analysis of Particles

A solution prepared by alkali fusion of 200 mg of the metal oxide nanoparticles was subjected to compositional analysis by means of inductively coupled plasma atomic emission spectrometry (ICP-AES), and molar amounts of core oxide and St and/or Ge forming a shell were measured. For example, when the metal M was titanium and when a silane coupling agent was used, the compositional ratio of titanium and silicon was determined. The compositions of a titanium component and a silicon component were assumed to be TiO₂ and SiO₂, respectively, and volume factors of TiO₂ and SiO₂ of a product were determined on the basis of their specific gravities.

(5) Measurement of Refractive Index of Particles

Formed particles were homogeneously dispersed in chloroform such that they had a volume factor of 10%, and they were measured for a refractive index. When the volume factor of particles is η and when the refractive index of a solvent is ns, the refractive index np of the particles is represented by

np=ns+(nm−ns)/η.

And, ns=1.45 and η=0.1 are substituted, the above expression comes to be

np=10 nm−13.05.

A measurement value is substituted to determine np.

Further, composites were identified by the following methods.

### <Identification of Composite>

(1) Observation of Composite Structure

A leaf taken from a prepared resin molded article by cutting was subjected to TEM observation, and it was observed how the particles were distributed in the resin.

(2) Measurement of Transmittance of Composite

A 2 mm thick resin molded article was measured for transmittance to light having a wavelength of 400 to 750 nm with a visible-ultraviolet spectrophotometer.

(3) Measurement of Refractive Index of Composite

A 2 mm thick resin molded article was measured for a refractive index with an Abbe refractometer with regard to light having a wavelength of 589 nm.

(4) Haze Value

Measured according to JIS K7136:2000.

### Example 1.1

### Synthesis of MPTS-TiO₂ Nanocrystal

8.90 Grams of sodium di(2-ethylhexyl)-sulfosuccinate (ACT) (supplied by Tokyo Chemical Industry Co., Ltd.), 3.60 ml of distilled water (supplied by Wako Pure Chemical Industries, Ltd.) and 0.77 g of p-toluenesulfonic acid monohydrate (PTSH; supplied by Wako Pure Chemical Industries, Ltd.) were added to 100 ml of xylene (supplied by Kanto Chemical Co., Inc.), and the mixture was stirred until it formed a homogenous solution, to prepare a reversed micelle. To this solution was added 3.78 ml of mercaptopropyltrimethoxysilane (MPTS) (supplied by Tokyo Chemical Industry Co., Ltd.), and the mixture was stirred at room temperature for 20 hours. To this solution was dropwise added a solution of 5.68 q of titanium tetraisopropoxide (TTIP) (supplied by Aldrich) in 40 g of n-hexyl alcohol. For promoting shell generation by crystallization of TiO₂ fine particles and dehydration-condensation of MPTS, further, the above solution was heated with a microwave heating apparatus (‘START-S’, supplied by Milestone General K.K.) at 80° C. for 1 hour and then at 140° C. for 2 hours, to synthesize an intended SiO₂-coated TiO₂ core-shell nanocrystal having mercapto group on its surface. At this stage, AOT remained on the nanocrystal surface.

An intended metal oxide nanocrystal was Isolated from the formed product and purified as follows. After the heating, the reaction solution was allowed to cool to room temperature, and approximately 600 ml of methanol (supplied by Kanto Chemical Co., Inc.) was added thereto to generate a white precipitate of a TiO₂ nanocrystal. After the precipitate was separated from a supernatant by centrifugal separation, and then approximately 25 ml of chloroform (supplied by Wako Pure Chemical Industries, Ltd.) was added, whereby the nanocrystal was homogeneously dispersed in the chloroform to give a colorless transparent solution. For complete removal of AOT, the addition of methanol, centrifugal separation and dispersing in chloroform were repeated five times. The formed product was well dispersed in chloroform and gave a colorless transparent solution. Finally, the solvent was removed by vacuum drying to give 1.82 g of a TiO₂ nanocrystal having the form of a white powder.

### <Identification Results>

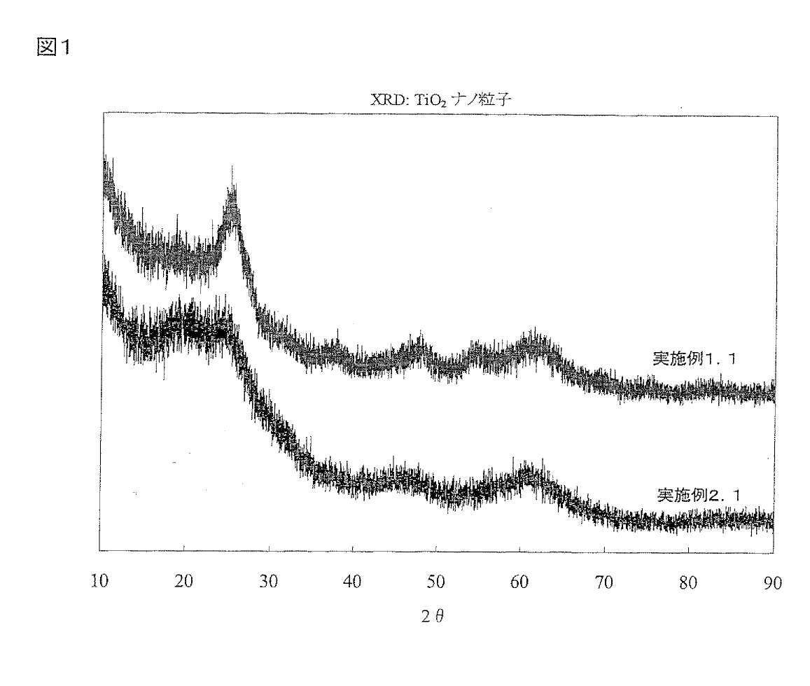

FIG. 1 shows the XRD pattern of the formed product. It was seen from FIG. 1 that the formed product had an anatase type crystal structure, and it was seen from the TEN observation result that the core Ti2 nanocrystal had an average particle diameter of 3.2 nm. In ¹H-NMR spectrum, a peak corresponding to a 3-mercaptopropyl group was measured, so that it was found that a functional group derived from MPTS was introduced onto the surface of each particle. Further, the anatase TiO₂ core had a volume factor of 0.84, and the product had a refractive index of 2.20+

### Example 1.2

### Synthesis of MPTS-ZrO₂ Nanocrystal

2.12 Grams of ZrO₂ nanocrystal having MPTS introduced on its surface was obtained in the same manner as in Example 1.1 except that TTIO was replaced with 7.67 g of zirconium tetra-n-butoxide (ZTB: supplied by Wako Pure Chemical Industries, Ltd.).

### <Identification>

From the results of XRD and TEM, it was seen that the core contained tetragonal-system ZrO₂ having an average particle diameter of 3.0 nm. In ¹H-NMR spectrum, a peak corresponding to a 3 mercaptopropyl group was measured, so that it was found that a functional group derived from MPTS was introduced onto the surface of each particle. Further, the tetragonal-system ZrO₂ core had a volume factor of 0.82, and the product had a refractive index of 1.96.

### Example 1.3

### Synthesis of MPTS-TiO₂ Nanocrystals Having Different Sizes

Syntheses were carried out in the same manner as in Example 1.1 except that the amounts of distilled water, PTSH, TTIP and MPTS were changed as follows.

| Ex. | H₂O (ml) | PTSH (g) | TTIP (g) | MPTS (ml) |
|---|---|---|---|---|
| (2) | 1.8 | 0.39 | 2.84 | 1.89 |
| (3) | 7.2 | 1.54 | 11.36 | 7.56 |
| (4) | 10.8 | 2.31 | 17.40 | 11.34 |
| (5) | 14.4 | 3.12 | 22.7 | 15.1 |

### <Identification>

| | | Core average | | |
|---|---|---|---|---|
| | | particle | | |
| | | diameter | Core volume | Refractive |
| Ex. | Anatase | (nm) | factor | index |
| (2) | ◯ | 1.6 | 0.72 | 1.68 |
| (3) | ◯ | 6.8 | 0.89 | 2.28 |
| (4) | ◯ | 10.9 | 0.94 | 2.38 |
| (5) | ◯ | 15.8 | 0.98 | 2.48 |

### Example 1.4

### Synthesis of MPTS-TiO₂ Nanocrystals Having Different Core/Shell Volume Factors

TiO₂ Nanocrystals having MPTS introduced on their surfaces were obtained in the same manner as in Example 1.1 except that 3.78 ml of MPTS was replaced with the following mixtures containing MPTS and tetraethoxysilane (TEOS).

Ex. (1) MPTS1.89 ml TEOS 2.29 ml MPTS:TEOS (molar ratio)=5:5

### Ex. (2) MPTS1.13 ml TEOS 3.20 ml MPTS:TEOS=3:7

### <Identification Results>

| | | Core average | | |
|---|---|---|---|---|
| | | particle | | |
| | | diameter | Core volume | Refractive |
| Ex. | Anatase | (nm) | factor | index |
| (1) | ◯ | 3.2 | 0.75 | 1.71 |
| (2) | ◯ | 3.2 | 0.59 | 1.61 |

### Example 1.5

### Synthesis of Ti2 Nanocrystals Having a Functional Group Other than MPTS

TiO₂ Nanocrystals having an acrylate group or an epoxycyclohexyl group on their surfaces were obtained in the same manner as in Example 1.1 except that 3.78 ml of MPTS was replaced with 4.69 g of 3-(trimethoxysilyl) propyl acrylate (TSPA: supplied by Tokyo Chemical Industries Co., Ltd.) or 4.60 ml of 2-(3,4-epoxycyclohexyl)ethyltrimethoxysilane (ECTS: supplied by Tokyo Chemical industries Co., Ltd.).

### <Identification>

| | | Core average | | |
|---|---|---|---|---|
| | | particle | | |
| Added | | diameter | Core volume | Refractive |
| material | Anatase | (nm) | factor | index |
| TSPA | ◯ | 3.1 | 0.82 | 2.19 |
| ECTS | ◯ | 3.3 | 0.81 | 2.18 |

### Example 1.6

### Synthesis of MPTS-HfO₂ Nanocrystal

4.32 Grams of a HfO₂ nanocrystal having MPTS introduced onto its surface was obtained in the same manner as in Example 1.1 except that TTIP was replaced with 9.41 g of hafnium tetra-t-butoxide (HTB: supplied by Strem Chemicals).

### <Identification>

From the results of XRD and TEM, it was seen that the formed product contained tetragonal-system HfO₂ having an average particle diameter of 3.0 nm. In ¹H-NMP spectrum, a peak corresponding to a 1-mercaptopropyl group was measured, so that it was found that a functional group derived from MPTS was introduced onto the surface of each particle. Further, the tetragonal-system ZrO₂ core had a volume factor of 0.83, and the product had a refractive index of 1.97.

### Example 1.7

### Synthesis of MPTS-Nb₂O₅ Nanocrystal

2.88 Grams of a Nb₂O₅ nanocrystal having MPTS introduced onto its surface was obtained in the same manner as in Example 1.1 except that TTIP was replaced with 9.1 g of niobium pentabutoxide (NPB: supplied by Kanto Chemical Co., Inc.).

### <Identification>

From the results of XRD and TEM, it was seen that the formed product contained orthorhombic-system Nb₂O₅ having an average particle diameter of 3.0 nm. In ¹H-NMR spectrum, a peak corresponding to a 1-mercaptopropyl group was measured, so that it was found that a functional group derived from MPTS was introduced onto the surface of each particle. Further, the orthorhombic-system Nb₂O₅ core had a volume factor of 0.83, and the product had a refractive index of 1.85.

### Example 1.8

### Synthesis of MPTS-Ta₂O₅ Nanocrystal

4.64 Grams of a Ta₂O₅ nanocrystal having MPTS introduced onto its surface was obtained in the same manner as in Example 1.1 except that TTIP was replaced with 9.53 g of tantalum pentaisopropoxide (TPP: supplied by Kanto Chemical Co., Inc.).

### <Identification>

From the results of XRD and TEM, it was seen that the formed product contained orthorhombic-system Ta₂O₅ having an average particle diameter of 3.0 nm. In ¹H-NMR spectrum, a peak corresponding to a 1-mercaptopropyl group was measured, so that it was found that a functional group derived from MPTS was introduced onto the surface of each particle. Further, the orthorhombic-system Ta₂O₅ core had a volume factor of 0.83, and the product had a refractive index of 1.90.

### <Summary of Example 1>

Properties of the synthesized crystals are summarized below.

| | Core average | | | |
|---|---|---|---|---|
| | particle | Core volume | Refractive | |
| Example | diameter (nm) | factor | index | [Ti]/[Si] |
| 1.1 | 3.2 | 0.84 | 2.20 | 6 |
| 1.2 | 3.0 | 0.82 | 1.96 | |
| 1.3(2) | 1.6 | 0.72 | 1.68 | |
| 1.3(3) | 6.8 | 0.89 | 2.28 | 7.5 |
| 1.3(4) | 10.9 | 0.94 | 2.38 | 8.2 |
| 1.3(5) | 15.8 | 0.98 | 2.48 | 9.8 |
| 1.4(1) | 3.2 | 0.75 | 1.71 | |
| 1.4(2) | 3.2 | 0.59 | 1.61 | |
| 1.5(1) | 3.1 | 0.82 | 2.19 | 5.6 |
| 1.5(2) | 3.3 | 0.81 | 2.18 | 5.8 |
| 1.6 | 3.0 | 0.83 | 1.97 | |
| 1.7 | 3.0 | 0.83 | 1.85 | |
| 1.8 | 3.0 | 0.83 | 1.90 | |

### Example 2.1

### Synthesis of MPTS-TiO₂ Amorphous Fine Particles

Procedures similar to those of Example 1.11 were carried out up to the addition of TTIP. For promoting the formation of a shell by dehydration condensation of MPTS, the thus-obtained solution was heated in an oil bath at 80° C. for 1 hour and then at 140° C. for 2 hours. An intended product was isolated and purified in the same manner as in Example 1. The thus-obtained product was excellently dispersed in chloroform and gave a colorless transparent solution. After vacuum drying, 1.83 g of fine particles having the form of a white powder was obtained.

### <Identification Results.

FIG. 1 shows an XRD pattern of the formed product. It was seen from FIG. 1 that the product had an amorphous structure, and it was seen from the TEN observation results that cores had an average particle diameter of 3.4 nm. In ¹H-NMR spectrum, a peak corresponding to a 3-mercaptopropyl group was measured, so that it was found that a functional group derived from MPTS was introduced onto the surface of each particle. Further, the amorphous TiO₂ core had a volume factor of 0.81, and the product had a refractive index of 2.23.

### Example 2.2

### Synthesis of MPTS-ZrO₂ Amorphous Fine Particles

2.15 Grams of ZrO₂ fine particles having MPTS introduced on each surface were obtained in the same manner as in Example 2.1 except that TTIO was replaced with 7.67 g of zirconium tetra-n-butoxide (ZTB: supplied by Wako Pure Chemical Industries, Ltd.)<Identification>

From the results of XRD and TEM observation, it was seen that they were amorphous fine particles having a core average particle diameter of 3.4 nom. In ¹-NMR spectrum, a peak corresponding to a 3-mercaptopropyl group was measured, so that it was found that a functional group derived from MPTS was introduced onto the surface of each particle. Further, the amorphous ZrO₂ core had a volume factor of 0.82, and they had a refractive index of 1.90.

### Example 2.3

### Synthesis of MPTS-TiO₂ Amorphous Fine Particles Having Different Sizes

Syntheses were carried out in the same manner as in Example 2.1 except that the amounts of distilled water, PTSH, TTIP and MPTS were changed as follows.

| Ex. | H₂O (ml) | PTSH (g) | TTIP (g) | MPTS (ml) |
|---|---|---|---|---|
| (2) | 1.8 | 0.39 | 2.84 | 1.89 |
| (3) | 7.2 | 1.54 | 11.36 | 7.56 |
| (4) | 10.8 | 2.31 | 17.40 | 11.34 |
| (5) | 14.4 | 3.12 | 22.7 | 15.1 |

### <Identification>

| | | Core average | | |
|---|---|---|---|---|
| | | particle | Core | |
| | | diameter | volume | Refractive |
| Ex. | Amorphous | (nm) | factor | index |
| (2) | ◯ | 1.8 | 0.70 | 1.67 |
| (3) | ◯ | 6.4 | 0.85 | 2.20 |
| (4) | ◯ | 11.1 | 0.91 | 2.37 |
| (5) | ◯ | 16.0 | 0.97 | 2.45 |

### Example 2.4

### Synthesis of MPTS-Composite Oxide Amorphous Fine Particles

TiO₂—ZrO₂ amorphous composite fine particles having MPTS introduced on each surface were synthesized by carrying out reactions in the same manner as in Example 2.1 except that 5.7 g of TTIP was replaced with mixtures containing TTIP, ZTB and niobium pentabutoxide (NUB: supplied by Kanto Chemical Co., Inc.) in the following ratios.

| | | | | Ti:Zr:Nb |
|---|---|---|---|---|
| Ex. | TTIP (g) | ZTB (g) | NPB (g) | (molar ratio) |
| (1) | 2.84 | 3.84 | 0 | 1:1:0 |
| (2) | 2.84 | 0 | 4.59 | 1:0:1 |
| (3) | 0 | 3.84 | 4.59 | 0:1:1 |

### <Identification>

| | | Core average | Component | | |
|---|---|---|---|---|---|
| | | particle | (molar) | Core | |
| | | diameter | ratio | volume | Refractive |
| Ex. | Amorphous | (nm) | Ti:Zr:Nb | factor | index |
| (1) | ◯ | 3.5 | 49:51:0 | 0.83 | 2.01 |
| (2) | ◯ | 3.4 | 48:0:52 | 0.81 | 1.87 |
| (3) | ◯ | 3.2 | 0:50:50 | 0.80 | 1.76 |

### Example 2.5

### Synthesis of MPTS-TiO₂/ZrO₂ Amorphous Fine Particles

Syntheses were carried out in the same manner as in Example 2.1 except that the amounts of distilled water, PTSH, TTIP and MPTS were changed as follows.

| Ex. | H₂O (ml) | PTSH (g) | TTIP (g) | ZTB (g) | MPTS (ml) |
|---|---|---|---|---|---|
| (2) | 1.8 | 0.39 | 1.42 | 1.92 | 1.89 |
| (3) | 7.2 | 1.54 | 5.68 | 7.72 | 11.34 |

### <Identification>

| | | Core average | | |
|---|---|---|---|---|
| | | particle | Core | |
| | | diameter | volume | Refractive |
| Ex. | Amorphous | (nm) | factor | index |
| (2) | ◯ | 1.7 | 0.65 | 1.62 |
| (3) | ◯ | 6.8 | 0.88 | 2.08 |

### Example 2.6

### Synthesis of MPTS-TiO₂ Amorphous Fine Particles Having Different Core/Shell Volume Factors

TiO₂ Amorphous fine particles having MPTS introduced onto each surface were obtained by carrying out reactions in the same manner as in Example 1.1 except that 3.78 ml of MPTS was replaced with the following mixtures containing MPTS and tetraethoxysilane (TEOS: supplied by Tokyo Chemical Industry Co., Ltd.). The above TEOS was used as a hydrolyzable material. Since TEOS is not any silane coupling agent, it has no influence on an organic functional group of a shell in a metal oxide nanocrystal to be obtained.

Ex. (1) MPTS1.89 ml TEOS 2.29 ml MPTS:TEOS (Molar ratio)=5:5

### Ex. (2) MPTS1.13 ml TEOS 3.20 ml MPTS:TEOS=3:7

### <Identification Results>

| | | Core average | | |
|---|---|---|---|---|
| | | particle | Core | |
| | | diameter | volume | Refractive |
| Ex. | Amorphous | (nm) | factor | index |
| (1) | ◯ | 3.3 | 0.74 | 1.70 |
| (2) | ◯ | 3.4 | 0.60 | 1.62 |

### Example 2.7

### Synthesis of TiO₂ Amorphous Fine Particles Having a Functional Group Other than MPTS

TiO₂ Amorphous fine particles having an acrylate group or an epoxycyclohexyl group on each surface were obtained in the same manner as in Example 2.1 except that 3.78 ml of MPTS was replaced with 4.69 g of 3-(trimethoxysilyl)propyl acrylate (TSPA: supplied by Tokyo Chemical Industry Co., Ltd.) or 4.61 ml of 2-(3,4-epoxycyclohexyl)ethyltrimethoxysilane (ECTS: supplied by Tokyo Chemical Industry Co., Ltd.).

### <Identification>

| | | Core average | | |
|---|---|---|---|---|
| | | particle | Core | |
| Material | | diameter | volume | Refractive |
| added | Amorphous | (nm) | factor | index |
| TSPA | ◯ | 3.3 | 0.80 | 2.17 |
| ECTS | ◯ | 3.2 | 0.82 | 2.19 |

### <Summary of Example 2>

Properties of the synthesized amorphous fine particles are summarized below.

| | Core average | Core | |
|---|---|---|---|
| | particle | volume | Refractive |
| Example | diameter (nm) | factor | index |
| 2.1 | 3.4 | 0.81 | 2.13 |
| 2.2 | 3.4 | 0.82 | 1.90 |
| 2.3 (2) | 1.8 | 0.70 | 1.67 |
| 2.3 (3) | 6.4 | 0.85 | 2.20 |
| 2.3 (4) | 11.1 | 0.91 | 2.37 |
| 2.3 (5) | 16.0 | 0.97 | 2.45 |
| 2.4 (1) | 3.5 | 0.83 | 2.01 |
| 2.4 (2) | 3.4 | 0.81 | 1.87 |
| 2.4 (3) | 3.2 | 0.80 | 1.76 |
| 2.5 (2) | 1.7 | 0.65 | 1.62 |
| 2.5 (3) | 6.8 | 0.88 | 2.08 |
| 2.6 (1) | 3.3 | 0.74 | 1.70 |
| 2.6 (2) | 3.4 | 0.60 | 1.62 |
| 2.7 (1) | 3.3 | 0.80 | 2.17 |
| 2.7 (2) | 3.2 | 0.82 | 2.19 |

### Example 3.1

### Synthesis of MPTS-TiO₂ Nanocrystal/Polythiourethane Composite—1

To 1 g of the MPTS-TiO₂ nanocrystal made in Example 1.1 were added 1 g of 1,3-bis(isocyanatomethyl) cyclohexane and 0.7 g of 2,5-bis(mercaptomethyl)-1,4-thiazine, and the mixture was degassed under reduced pressure for 1 hour. It was filtered with a 1 μm Teflon filter and then injected into a mold composed of a glass mold and a gasket. While the mold was gradually temperature-increased from 40° C. to 120° C., it was allowed to undergo polymerization for 20 hours. After completion of the polymerization, a product was gradually cooled and taken out of the mold. The thus-obtained resin was annealed at 120° C. for 3 hours to give a resin molded article.

### <Identification Results>

In TEM measurement, there was observed a structure in which the fine particles were dispersed in the resin in a state where the fine particles were 5 nm or more apart from one another. From this observation result, it was found that the fine particles were homogeneously dispersed in the resin without causing any aggregation of fine particles. The molded article had a transmittance of 84%, a haze value of 4% and a refractive index of: 1.78. Since the refractive index without any TiO₂ nanocrystal added had been 1.60, it was shown that the addition of TiO₂ nanocrystal produced an effect on an improvement in refractive index.

### Example 3.2

### Synthesis of MPTS-ZrO₂ Nanocrystal/Polythiourethane Composite—1

A resin molded article was obtained in the same manner as in Example 3.1 except that the MPTS-TiO₂ nanocrystal was replaced with the MPTS-ZrO₂ nanocrystal obtained in Example 1.2.

### <Identification Results>

From TEM measurements it was found that the fine particles were homogeneously dispersed in the resin without causing any aggregation of fine particles. The molded article had a transmittance of 86%, a haze value of 3% and a refractive index of 1.70. Since the refractive index without any ZrO₂ nanocrystal added had been 1.60, it was shown that the addition of ZrO₂ nanocrystal produced an effect or an improvement in refractive index.

### Example 3.3

### Synthesis of MPTS-TiO₂ Nanocrystal/Polythiourethane Composite—2

Resin molded articles were obtained in the same manner as in Example 3.1 except that the formed product in Example 1.1 was replaced with MPTS-TiO₂ nanocrystals obtained in Example 1.3.

### <Identification Results>

| | | | Haze | Refractive |
|---|---|---|---|---|
| Example | Dispersibility | Transmittance | value | index |
| (2) | ◯ | 92% | 3% | 1.62 |
| (3) | ◯ | 82% | 6% | 1.79 |
| (4) | ◯ | 78% | 9% | 1.83 |
| (5) | ◯ | 75% | 10% | 1.86 |

### Example 3.4

### Synthesis of MPTS-T O₂ Nanocrystal/Polythiourethane Composite—31

Resin molded articles were obtained in the same manner as in Example 3.1 except that the amount of the MPTS-TiO₂ nanocrystal obtained in Example 1.1 and used in Example 3.1 was changed as follows.

### <Identification Results>

| | Nanocrystal | | | Haze | Refractive |
|---|---|---|---|---|---|
| Ex. | (g) | Dispersibility | Transmittance | value | index |
| (1) | 0.5 | ◯ | 95% | 3% | 1.69 |
| (2) | 1.5 | ◯ | 80% | 9% | 1.87 |
| (3) | 2.0 | ◯ | 78% | 10% | 2.12 |

### Example 3.5

### Synthesis of TiO₂ Nanocrystal/Polythiourethane Composite—4

Resin molded articles were obtained Ian the same manner as in Example 3.1 by the use of the TiO₂ nanocrystals obtained in Example 1.4.

### <Identification Results>

| | | | Haze | Refractive |
|---|---|---|---|---|
| Example | Dispersibility | Transmittance | value | index |
| (1) | ◯ | 83% | 5% | 1.63 |
| (2) | ◯ | 81% | 7% | 1.61 |

### <Summary of Example 3>

The properties of the resin molded articles made by the use of nanocrystals are summarized below.

| | | Haze | Refractive |
|---|---|---|---|
| Example | Transmittance | value | index |
| 3.1 | 84% | 4% | 1.78 |
| 3.2 | 86% | 3% | 1.70 |
| 3.3 (2) | 92% | 3% | 1.62 |
| 3.3 (3) | 82% | 6% | 1.79 |
| 3.3 (4) | 78% | 9% | 1.83 |
| 3.3 (5) | 75% | 10% | 1.86 |
| 3.4 (1) | 95% | 3% | 1.69 |
| 3.4 (2) | 80% | 9% | 1.87 |
| 3.4 (3) | 78% | 10% | 2.12 |
| 3.5 (1) | 83% | 5% | 1.63 |
| 3.5 (2) | 81% | 7% | 1.61 |

### Example 4.1

### Synthesis of MPTS-TiO₂ Amorphous Fine Particles/Polythiourethane Composite—1

A resin molded article was obtained in the same manner as in Example 3.1 by the use of 1 g of the MPTS-TiO₂ amorphous fine particles made in Example 2.1.

<Identification results.

In TEM measurement, there was observed a structure in which the fine particles were dispersed in the resin in a state where the fine particles are 5 nm or more apart from one another. From this observation result, it was found that the fine particles were homogeneously dispersed in the resin without causing any aggregation of fine particles. The molded article had a transmittance of 86%, a haze value of 3 c and a refractive index of 1.76. It was shown that the addition of TiO₂ amorphous fine particles produced an effect on an improvement in refractive index.

### Example 4.2

### Synthesis of MPTS-ZrO₂ Amorphous Fine Particles/Polythiourethane Composite

A resin molded article was obtained in the same manner as in Example 3.1 by the use of the MPTS-ZrO₂ amorphous fine particles obtained in Example 2.2.

### <Identification Results>

From TEM measurement, it was found that the fine particles were homogeneously dispersed in the resin without causing any aggregation of fine particles. The molded article had a transmittance of 82%, a haze value of 4% and a refractive index of 1.69. Since the refractive index without any ZrO₂ amorphous fine particles added had been 1.60, it was shown that the addition of ZrO₂ nanoparticles produced an effect on an improvement in refractive index.

### Example 4.3

### Synthesis of MPTS-TiO₂ Amorphous Fine Particles/Polythiourethane Composite—2

Resin mold articles were obtained in the same manner as in Example 4.1 except that the formed product in Example 2.1 was replaced with the MPTS-TiO₂ amorphous fine particles obtained in Example 2.3.

### <Identification Results>

| | | | Haze | Refractive |
|---|---|---|---|---|
| Example | Dispersibility | Transmittance | value | index |
| (2) | ◯ | 92% | 3% | 1.62 |
| (3) | ◯ | 82% | 6% | 1.78 |
| (4) | ◯ | 75% | 9% | 1.83 |
| (5) | ◯ | 75% | 10% | 1.86 |

### Example 4.4

### Synthesis of MPTS-Composite Amorphous Fine Particles/Polythiourethane Composite

Resin molded articles were obtained in the same manner as in. Example 3.1 by the use of the MPTS-composite amorphous fine particles obtained in Example 2.4.

### <Identification Results>

| | | | Haze | Refractive |
|---|---|---|---|---|
| Example | Dispersibility | Transmittance | value | index |
| (1) | ◯ | 92% | 3% | 1.72 |
| (2) | ◯ | 82% | 6% | 1.68 |
| (3) | ◯ | 80% | 10% | 1.65 |

### Example 4.5

### Synthesis of MPTS-TiO₂ Amorphous Fine Particles/Polythiourethane Composite—2

Resin molded articles were obtained in the same manner as in Example 3.1 by the use of the MPTS-amorphous fine particles obtained in Example 2.1 while the amount of the fine particles was changed as follows.

### <Identification Results>

| | Fine | | | | |
|---|---|---|---|---|---|
| | particles | | | Haze | Refractive |
| Ex. | (g) | Dispersibility | Transmittance | value | index |
| (1) | 0.5 | ◯ | 94% | 2% | 1.68 |
| (2) | 1.5 | ◯ | 82% | 8% | 1.84 |
| (3) | 2.0 | ◯ | 79% | 9% | 2.08 |

### Example 4.6

### Synthesis of TiO₂ Amorphous Fine Particles/Polythiourethane Composite—3

Resin molded articles were obtained in the same manner as in Example 3.1 by the use of the TiO₂ amorphous fine particles obtained in Example 2.6.

### <Identification Results>

| | | | Haze | Refractive |
|---|---|---|---|---|
| Example | Dispersibility | Transmittance | value | index |
| (1) | ◯ | 85% | 6% | 1.63 |
| (2) | ◯ | 82% | 8% | 1.61 |

### <Summary of Example 4>

The properties of the resin molded articles made by the use of the amorphous fine particles are summarized below.

| | | Haze | Refractive |
|---|---|---|---|
| Example | Transmittance | value | index |
| 4.1 | 86% | 3% | 1.76 |
| 4.2 | 82% | 4% | 1.69 |
| 4.3 (2) | 92% | 3% | 1.62 |
| 4.3 (3) | 85% | 6% | 1.78 |
| 4.3 (4) | 78% | 9% | 1.83 |
| 4.3 (5) | 75% | 10% | 1.86 |
| 4.4 (1) | 92% | 3% | 1.72 |
| 4.4 (2) | 82% | 6% | 1.68 |
| 4.4 (3) | 80% | 10% | 1.65 |
| 4.5 (1) | 94% | 2% | 1.68 |
| 4.5 (2) | 82% | 8% | 1.84 |
| 4.5 (3) | 79% | 9% | 2.08 |
| 4.6 (1) | 85% | 6% | 1.63 |
| 4.6 (2) | 82% | 8% | 1.61 |

### Example 5

### TiO₂ Nanocrystal/Silicone Resin Composite

In the silicone resin used in this Example, a hydrosilyl group Si—H and a vinyl group were caused to undergo condensation-crosslinking by hydrosilylation in the presence of a platinum complex catalyst to effect curing. Therefore, TiO₂ fine particles each having a C═C double bond in a ligand on a surface were synthesized first, and when a resin was cured, they were mixed with the resin to introduce the fine particles into molecules of the resin.

### Example 5.1

### Synthesis of TiO₂ Nanocrystal Having an Allyl Group Introduced onto a Surface

1.72 Grams of a TiO₂ nanocrystal having an allyl group introduced onto a surface was obtained in the same manner as in Example 1.1 except that 3.78 ml of MPTS was replaced with 4.49 ml of allyltriethoxysilane (supplied by Tokyo Chemical Industry Co., Ltd.). By its identification, it was found that the formed product was a TiO₂ nanocrystal having a core average particle diameter of 3.4 nm and having an anatase crystal structure, and Chat it had an allyl group on its surface. The core had a volume factor of 0.86, and the formed product had a refractive index of 2.22.

### Example 5.2

### Synthesis of Amorphous TiO₂ Fine Particles Having an Allyl Group Introduced onto a Surface

1.74 Grams of TiO₂ fine particles each having an allyl group introduced onto a surface were obtained in the same manner as in Example 2.1 except that 3.78 ml of MPTS was replaced with 4.49 ml of allyltriethoxysilane (supplied by Tokyo Chemical Industry Co., Ltd.). By its identification, it was found that the formed product was TiO₂ fine particles each having a core average particle diameter of 3.6 nm and having an allyl group on its surface. The core had a volume factor of 0.84, and the formed product had a refractive index of 2.18.

### Example 5.3

### Synthesis of Allyl-TiO₂ Nanocrystal/Silicon Resin Composite

The following amounts by mass of the allyl-group-containing TiO₂ nanocrystal obtained in Example 5.1 was mixed with an LED-sealing resin “SR-7010” (A liquid 1 g, B liquid 1 g) supplied by Dow Corning Toray Co., Ltd., and the mixture was cast into a mold formed of a glass mold and a gasket. While the mold was gradually temperature-increased from 40° C. to 150° C. it was allowed to undergo polymerization for 5 hours. After completion of the polymerization, a resin was gradually cooled and taken out of the mold to give a resin molded article.

### <Identification Results>

| | Nanocrystal | | | Haze | Refractive |
|---|---|---|---|---|---|
| Ex. | (g) | Dispersibility | Transmittance | value | index |
| (1) | 1 | ◯ | 83% | 5% | 1.62 |
| (2) | 2 | ◯ | 81% | 7% | 2.05 |

Since the resin containing no fine particles had a refractive index of 1.51, it was shown that the addition of the TiO₂ nanocrystal produced an effect on an improvement in refractive index.

### Example 5.4

### Synthesis of Allyl-Amorphous TiO₂ Fine Particles/Silicone Resin Composite

Resin molded articles were obtained in the same manner as in Example 5.3 except that the following amounts by mass of the allyl-group-containing TiO₂ amorphous fine particles obtained in Example 5.2 were used.

### <Identification Results>

| | Nanoparticle | | | Haze | Refractive |
|---|---|---|---|---|---|
| Ex. | (g) | Dispersibility | Transmittance | value | index |
| (1) | 1 | ◯ | 84% | 5% | 1.60 |
| (2) | 2 | ◯ | 80% | 6% | 2.02 |

Since the resin containing no fine particles had a refractive index of 1.51, it was shown that the addition of the TiO₂ amorphous fine particles produced an effect on an improvement in refractive index.

### <Summary of Example 5>

The properties of TiO₂ fine particles having an allyl group introduced are summarized bellow.

| | | Core average | Core | |
|---|---|---|---|---|
| | | particle | volume | Refractive |
| Ex. | Crystallinity | diameter (nm) | factor | index |
| 5.1 | Anatase | 3.4 | 0.86 | 2.22 |
| 5.2 | Amorphous | 3.6 | 0.84 | 2.18 |

The properties of the silicone resin composites produced by the use of the TiO₂ fine particles having an allyl group introduced are summarized below.

| | | Haze | Refractive |
|---|---|---|---|
| Example | Transmittance | value | index |
| 5.3 (1) | 83% | 5% | 1.62 |
| 5.3 (2) | 81% | 7% | 2.05 |
| 5.4 (1) | 84% | 5% | 1.60 |
| 5.4 (2) | 80% | 6% | 2.02 |

### INDUSTRIAL UTILITY

The metal oxide nanoparticles of this invention can be homogeneously dispersed in a matrix resin without causing secondary aggregation and are nanoparticles that have a high refractive index and are colorless. They can give a nanoparticles-dispersed resin having a high refractive index and excellent colorless transparency, which are suitable for plastic ophthalmic lenses and suitable as a sealant for LED, etc.

1. Metal oxide nanoparticles each having a core formed of a metal oxide having at least one element selected from elements of the groups 4 and 5, and a shell having a coating portion that has Si and/or Ge element(s) and that is formed on the circumference of said core to coat said core, and an organic functional group that is bonded to said Si and/or Ge element(s).

2. The metal oxide nanoparticles of claim 1, which have a molar ratio of [M]/[Si Ge]≧4,
in which [M] is a molar amount of the at least one element selected from elements of the groups 4 and 5, and [Si Ge] is a molar amount of Si and/or Ge element(s) contained in the coating portion of said shell.

3. The metal oxide nanoparticles of claim 1, which have a molar ratio of [F]/[Si Ge]=1 or 2,
in which [F] is a molar amount of molecules of said organic functional group contained in said shell, and [Si Ge] is a molar amount of Si and/or Ge element(s) contained in said shell.

4. The metal oxide nanoparticles of claim 1, wherein said core has a volume factor of 0.6 or more but less than 1.

5. The metal oxide nanoparticles of claim 1, wherein the metal oxide of said core has a crystalline structure.

6. The metal oxide nanoparticles of claim 1, wherein the metal oxide of said core is amorphous.

7. The metal oxide nanoparticles of claim 1, wherein the metal oxide of said core represents at least two members selected from TiO₂, ZrO₂, HfO₂, Nb₂O₅ and Ta₂O₅.

8. A process for producing metal oxide nanoparticles of claim 1, wherein said coating portion and said organic functional group is formed from identical raw materials having Si and/or Ge element(s).

9. The process for producing metal oxide nanoparticles as recited in claim 8, wherein the raw material for said coating portion and said organic functional group is a silane coupling agent and/or a germanium coupling agent.

10. The process for producing metal oxide nanoparticles as recited in claim 8, wherein the raw material for said coating portion and said organic functional group is Rn—Y-Xm in which R is an organic functional group, Y is Si and/or Ge, X is OR′, Cl, Br or “COR” in which R′ and R″ are hydrogen atoms or hydrocarbon groups, and n and m are numbers of 1 or more but 3 or less and satisfy n+m=4.

11. The process for producing metal oxide nanoparticles as recited in claim 8, which comprises the steps of (A) forming a reversed micelle internally having fine water globules in an organic solvent, (B) allowing each of an alkoxide compound of at least one metal M selected from elements of the group 4 and 5, a silane coupling agent and/or a germanium coupling agent having non-hydrolyzable organic functional groups and hydrolyzable groups, and optionally, a hydrolyzable material to undergo hydrolysis condensation using, as a reaction site, an inside of the reversed micelle formed in said step (A), to form a silicon compound and/or a germanium compound having a non-hydrolyzable group and a hydroxyl group around oxide particles of the metal M, and (C) heat-treating the reaction solution obtained in said step (B), to form metal oxide nanoparticles each having a core-shell structure having an oxide particle of the metal M as a core, the silicon compound and/or the germanium compound as a coating portion and the non-hydrolyzable group as a shell.

12. The process for producing metal oxide nanoparticles as recited in claim 8, which comprises the steps of (D) forming a reversed micelle internally having fine water globules in an organic solvent, (E) adding an alkoxide compound of at least one metal M selected from the elements of the groups 4 and 5, a silane coupling agent and/or a germanium coupling agent having non-hydrolyzable organic functional groups and hydrolyzable groups, and optionally, a hydrolyzable material to the organic solvent in said step (D), and (F) heat-treating the organic solvent in said step (E) to allow each to undergo dehydration-condensation.

13. The process for producing metal oxide nanoparticles as recited in claim 11, wherein said heat treatment is heat treatment by microwave.

14. The process for producing metal oxide nanoparticles as recited in claim 11, wherein the metal oxide particles of the metal M is crystallized by said heat treatment.

15. The process for producing metal oxide nanoparticles as recited in claim 11, wherein the fine globules in said reversed micelle have an acidity.

16. A nanoparticles-dispersed resin comprising a matrix resin and the metal oxide nanoparticles recited in claim 1 which are dispersed therein.

17. The nanoparticles-dispersed resin of claim 16, wherein said matrix resin and said organic functional group of each shell of said metal oxide nanoparticles are chemically bonded to each other.

18. The nanoparticles-dispersed resin of claim 16, wherein said matrix resin is polythiourethane.

19. The nanoparticles-dispersed resin of claim 16, wherein said matrix resin is a silicone resin.

20. A process for producing the nanoparticles-dispersed resin of claim 16, which comprises using said matrix resin and said organic functional group in a manner that one of them has a group of Si—H and the other has a group of C=C.

21. The process for producing a nanoparticles-dispersed resin of the above (20), wherein said matrix resin is a silicone resin, and the hydrosilyl group Si—H and the vinyl group C=C are allowed to undergo condensation and crosslinking by hydrosilylation in the presence of a platinum complex catalyst.
